(19) United States
(12) Patent Application Publication
(10) Pub. No.: US 2026/0219214 A1
(43) Pub. Date: Jul. 30, 2026

(54) AN ALLOY ANALYSIS AND DEVELOPMENT METHOD

(71) Applicant: Kamil Armagan GUL, Istanbul (TR)

(72) Inventor: Kamil Armagan GUL, Istanbul (TR)

(21) Appl. No.: 19/144,635

(22) PCT Filed: Dec. 27, 2023
(86) PCT No.: PCT/TR2023/051744

§ 371 Date: Jun. 30, 2025

(30) Foreign Application Priority Data
Dec. 30, 2022 (TR) 2022/021669

(51) Int. Cl. G01N 23/046; G01N 15/08; G01N 23/18

(52) U.S. Cl. CPC G01N 23/046; G01N 15/08; G01N 23/18; G01N 2015/0846; G01N 2223/401; G01N 2223/624

(57) ABSTRACT

This invention pertains to a method of porous metal plasticity, for analyzing and enhancing alloys. The method involves usage of computed tomography scan to model the material structure to determine the location and density of porosity by regions; subsequently, the porosity areas are processed by using a voxel meshing method by tessellation, following the prior characterization of the alloy by partitioning it into “n” different virtual regions to create a substructure; the primary objective is to improve the strength and development of alloys by analyzing their porosities, especially in deformation regions, employing at least one computed method for modeling.

### TECHNICAL FIELD

The invention pertains to a methodology aimed at enhancing the strength of alloys by analyzing and addressing the porosities inherent to said alloys. Specifically, the method focuses on improving the alloy through an analysis of its porosities and reinforcing strength toward deformation zones.

### PRIOR ART

the design phase using various analysis programs, and the design of the components can be facilitated based on the conducted design analyses. For instance, forces acting on a component in a computer environment, as well as elongation scenarios, can be analyzed, allowing for the determination of stress distribution within the component. However, these studies are not sufficient for the development of a new alloy.

Therefore, the obtained samples are scanned using computed tomography (CT) scanning (CTS) techniques to examine their structural properties. However, the evaluation of these structural features can vary due to many factors from the alloy's casting process to its processing stages. For example, structural characteristics of a sample taken from the same alloy mixture can differ between a part obtained from casting into a sand mold and a part obtained from casting into a steel mold, even if taken from the same ladle.

Porosities/defects may exist in the structure of alloy components, and these flaws can directly impact the service life of the part. In practical applications, the detection of such flaws and the improvement of the alloy's structure have become significant technical challenges.

In the methods used in the prior art, the porosity density ratio of a scanned part cannot be precisely determined. For instance, upon examining a given porosity ratio of a part on which the porosity is distributed over the throughout the part not densely and comparing it with a part that shows a porosity density only over a specific region, their overall porosity ratios may appear the same. However, the quality of these two parts is entirely different. Therefore, there is a need for innovation to address technical challenges such as in this scenario example.

During the preparation stage of alloys, especially in aluminum alloys (e.g., aluminum-titanium-magnesium), metal oxides tend to form. These oxides are oriented hydrodynamically during the flow, exhibit different opening-up/geometrical features and can create irregularities in the part that is being cast. At this point, these metal oxides tend to behave like porosity on the said part. The parameters such as turbulence during casting and cooling rate directly affect the formation of metal oxides. Therefore, it is crucial to analyze alloy samples to determine casting parameters.

As a result, all the issues mentioned above have necessitated the need for an innovation in the relevant field.

### AIM OF THE INVENTION

The present invention aims to eliminate the before-mentioned problems and it is therefore proposed with the aim of bringing about a technical innovation in the relevant field.

The main objective of the invention is to establish a methodology enabling the analysis of porosity distribution after computed scanning of the parts, where the results of the computed scans are divided at the mesh/grid structure based on regional porosity distributions of the part.

Another objective of the invention is to prevent the formation of weakness in the strength of components in aluminum alloys due to the formation of metal oxides.

Another aim of the invention is related to provide an establishment of a quality index and minimum quality level which provide consistent results in all conditions, based during determination of liquid metal quality, and based during determination of a quality of a part with complex geometry.

Another objective of the invention is to prevent the formation of weaknesses of the parts due to the formation of metal oxides within the structure, particularly in aluminum-titanium-magnesium alloys.

Another aim of the invention is to develop alloy characteristics that behave within the desired properties, as well as to determine parameters such as casting angle, casting temperature, and cooling temperature specifically for the said developed alloy.

Another aim of the invention is to enable a method for the prediction of the material/alloy strength.

Another aim of the invention is to apply segmentation of the overall part region based on local defect densities of the said part rather than considering the global defect density of the said part during the analysis of defects of the said part.

The invention also aims to enhance the identification methods of failure causes by analyzing the alloy sample based on computed tomography scan results.

Another aim of the invention is to enable a better analysis of parts with localized/regional distribution of porosities when compared to parts with non-localized/global porosity distribution over the whole part region.

Furthermore, another aim of the invention is to develop an alloy with improved properties by using scanning parameters in the development stage of the said alloy.

### BRIEF DESCRIPTION OF THE INVENTION

The present invention, as described above and detailed further below, is an alloy analysis and development method designed to achieve all the mentioned objectives.

The invention is a method A method in order to increase the strength and facilitate the improvement of alloys which involves scanning and modeling the alloy with at least one computed tomography scanning method which allows the analysis of the inherent porosities and in particular, the metal oxide percentage in deformed regions is provided characterized in that; obtaining a sample with at least one casting process, conducting computed scanning to determine the location and density of the porosity regions of the material based on the scanning results, dividing the porous part into ‘n’ different virtual regions to establish a substructure, processing the identified porosities using a meshing method after tessellation and later analyze the determined porosity of the metal using the plasticity method.

A method in order to increase the strength and facilitate the improvement of alloys which involves scanning and modeling the alloy with at least one computed tomography scanning method which allows the analysis of the inherent porosities and in particular, the metal oxide percentage in deformed regions is provided characterized in that; obtaining a sample with at least one casting process, conducting computed scanning to determine the location and density of the porosity regions of the material based on the scanning results, dividing the porous part into ‘n’ different virtual regions to establish a substructure, processing the identified porosities using a meshing method after tessellation and later analyze the determined porosity of the metal using the plasticity method.

In another preferred embodiment of the invention, to enhance the strength and to promote development of the alloys by allowing the analysis of their porosities, metal oxide ratios, especially within deformed regions of the part are being performed, by following steps:
a) Prior production of the said alloy and conducting mechanical tests;
   i) Determination of effective global/local representative volume dimensions through computed tomography of the said alloy;
   ii) Save the data of surface areas and volumes of defects detected in computed tomography scans of said alloy;
   iii) Construction of a Test-Tomography correlation matrix/card;
b) Input of the parameters specific to alloy and part
c) Scanning the part by CT:
   i) Determination of effective global/local representative volume through computed tomography (CT);
   ii) Save the data of surface areas and volumes of the defects detected in CT scans of said alloy;
   iii) Conducting CT analysis to determine porosity and metal oxide ratio (percentage) by using the correlation data which includes heat treatment and cooling rate (solidification) data;
d) Determination of local density differences of virtual regions and dividing the alloy's/part's virtual data into mesh grids;
e) Division of the geometry data and/or grids into “n” different said regions based on the said determined regions with variable densities;
f) Construction of the substructure from “n” regions;
g) Separation of regions into meshed structures using the Tessellation algorithm by determining the degree of porosity/metal oxide ratio of each region;
h) Correlate the data obtained from the test step with the data obtained from casting and CT scans;
i) Recall required data from the built-in data matrix from test and CT scan stage
j) Determination of the alloy quality index and display on the geometry by projection;
k) Display of Alloy Quality Index of regions for each subregion and identification of weak points in casting accordingly;
l) Creation of the porous metal plasticity model, defining “n” different materials for “n” different said regions, writing parameters from the data matrix, and running the simulation (ex. Finite Element);
m) Project the said obtained results onto the part and identify weak points of the said part.

In another preferred embodiment of the invention, the Alloy Quality Index mentioned in step j is determined by assigning the volume defect and surface area defects quantities from CT scan into each unit volume. The Alloy Quality Index is calculated using the formula:

$$Alloy Quality Index = ( Yield Strength + Tensile Strength + Elongation ) - A ⋆ ( Volume Defect \times Surface Area of Defect ) b$$

In another preferred embodiment of the invention, calculations are performed for each volume that were pre-determined by sub-division.

In the same preferred embodiment, the tessellation algorithm is used to perform the meshing process mentioned in step d.

In another preferred embodiment of the invention, before step i, heat treatment results and regional porosity level are checked along with the data from mechanical tensile tests to construct the data matrix.

In another preferred embodiment, strength results are constructed through correlation of Volume defects, Surface defects and fv (the initial porosity ratio coefficient) which have been recovered from test data.

In another preferred embodiment of the invention, the AI sparse learning algorithm is used to perform modeling via damage evolution plasticity, lifetime calculations, and strength calculations.

In the same preferred embodiment, the Alloy Quality Index is determined according to the formula below:

$$Alloy Quality Index = ( Yield Strength + Tensile Strength + Elongation ) - A ⋆ ( Volumeof Defect ) b - A ⋆ ( Volume of Defect \times SurfaceArea of Defect ) b$$

In another preferred embodiment, the Gurson algorithm is used for the porous metal plasticity model.

In the same preferred embodiment, the Gurson-Tvergaard-Needleman algorithm is used for the porous metal plasticity model.

In another preferred embodiment, the Rousselier algorithm is used for the porous metal plasticity model.

In the same preferred embodiment, the Gologanu algorithm is used for the porous metal plasticity model.

In another preferred embodiment of the invention, the scanned part or parts via CT are segmented into regions and into mesh grids based on their porosity levels obtained from the results of same CT scan.

In another preferred embodiment of the invention, subsequent to tomography scans, constructed tessellation grid is further divided into sections to create a substructure based on inherent porosity density and locations of the said porosity. Said substructure is then meshed by voxel meshing method to perform analysis through porous metal plasticity.

In another preferred embodiment of the invention, to use porous metal plasticity algorithm, methodology includes a database matrix that was created by heat treatment results and regional porosity data.

In another preferred embodiment of the invention, while performing the porous metal plasticity analysis by defining “n” different materials parameters to each “n” number of sub-regions, the said parameters are assigned to said sub-regions.

In another preferred embodiment of the invention, global and local porosity analysis of the part is done to determine different porosity densities within different regions of the part.

In another preferred embodiment of the invention, following the creation of sub-structure from “n” sub-regions with associated level of porosities, stress intensity factors are assigned to the said regions by defining interface/boundary elements.

In another preferred embodiment of the invention, stress intensity factor is calculated by correlating with sphericity/compactness values.

In another preferred embodiment of the invention, following step F, stress concentration is calculated with J2 plasticity.

In another preferred embodiment of the invention, calculation of the before-mentioned factor is being done by J2 plasticity and assigned by local stress concentration as the coefficients of local stress concentrations.

In another preferred embodiment of the invention, by considering projections of local or global dimensions of the defects along x, y, z axes or along xy, xz, yz planes, which assumes random orientation of the said defects to pinpoint crack initiation points and determines damage sensitivity by specifying crack size.

In another preferred embodiment of the invention, the voxel meshing method is used.

It is important to note that the scope of the invention, as defined in the claims, is not limited to the specific details described in this brief and detailed explanation. It is clear that a person skilled in the art can present similar embodiments in the light of the above descriptions without departing from the main theme of the invention.

### BRIEF DESCRIPTION OF FIGURES

In FIG. 1, the flowchart of an algorithm of the said invention explaining the operation steps is provided.

In FIGS. 2 and 3, flowcharts illustrating the methodology that is being used for a preferred embodiment of the invention are presented.

In FIG. 4, an example CT scanning image showing the result of the said CT scan is provided.

FIG. 5 shows an image of a specimen part into meshes/sections posterior to CT scanning.

In FIGS. 6A, 6B, and 6C, graphical representations of the defect distribution identified in the analysis are presented.

In FIG. 7, another algorithm explaining the operation of the invention is provided.

The drawings are not intended to limit the scope defined in the claims and should not be referred to independently without consulting the technical description in the disclosure of the present invention to interpret the scope defined in those claims.

These drawings aim to contribute to the clarity of the description of the invention.

### DESCRIPTION OF THE INVENTION

In this detailed description, the subject of the invention “method for alloy analysis and development” is described by means of examples that do not impose any limiting effect, solely for a better understanding.

The invention relates to a method that aims enhancing the strength of alloys by analyzing the inherent porosities (pores) and improving the alloy to increase the strength in its deforming regions.

The invention specifically relates to a method that involves segmentation of the alloy/part structure to regions according defect content level of said regions to allow local examination by Computed Tomography Scan of the structure independently.

The invention is a method for enhancing the strength and for development of alloys by enabling the analysis of porosities and, particularly, the metal oxide percentage within deformation (deformed) regions of the material. It involves scanning of the alloy/part using at least one computed tomography scanning method to model it. The distinctive feature of the method includes obtaining a sample through at least one casting process, analyzing the porous metal's plasticity using computerized scanning results to determine the location and density of porosity regions in the material. Additionally, the method involves characterizing the porous part by dividing it into “n” different virtual regions before processing with a meshing method after tessellation to create a framework.

Invention is characterized by following steps:
a) Pre-production of the said alloy and conducting mechanical tests,
   i) Determination of effective global/local representative volume dimensions through computed tomography of the said alloy
   ii) Save the data of surface areas and volumes of defects detected in computed tomography scans of said alloy.
   iii) Construction of a Test-Tomography correlation matrix/card.
b) Input of the parameters specific to alloy and part
c) Scanning the part by CT:
   i) Determination of effective global/local representative volume through computed tomography (CT);
   ii) Save the data of surface areas and volumes of the defects detected in CT scans of said alloy;
   iii) Conducting CT analysis to determine porosity and metal oxide ratio by using the correlation data which includes heat treatment and cooling rate data;
d) Determination of regional density differences and dividing the alloy/part data into grids according to the before mentioned regions with variable densities;
e) Division of the geometry data and/or grids into “n” different virtual regions based on the said determined regions with variable densities;
f) Construction of the substructure from “n” regions;
g) Separation of regions into meshed structures using the Tessellation algorithm by determining the degree of porosity/metal oxide ratio of each region;
h) Correlate the data obtained from the test step with the data obtained from casting and CT scans;
i) Recall required data from the built-in data matrix from test and CT scan stage;
j) Determination of the alloy quality index and display on the geometry by projection;
k) Display of locations of Alloy Quality Index values for each subregion and identification of weak points in casting accordingly;
l) Creation of the porous metal plasticity model, defining “n” different materials for “n” different virtual regions, writing parameters from the data matrix, and running the simulation;
m) Project the said obtained results onto the part and identify of weak points of the said part.

The invention enables the segmentation of the part based on the porosity density and spatial distribution of the said porosities within the part as determined by Computed Tomography Scanning results, further enabling the analysis of the before-mentioned segments using a porous metal plasticity method.

FIG. 2 provides a flow diagram illustrating a preferred embodiment of the invention.

Within the scope of the invention, alloy parameters are first determined, and the alloy is virtually scanned, the said scanning is performed with computed tomography. As a result of this scanning, the surface of the part is segmented using the tessellation method. The structure segmented by tessellation is divided into a substructure based on the density distribution and position of the porosities that are computed in the part. The number of these substructures can be ‘n.’ The mentioned ‘n’ substructures are meshed as a network through the three-dimensional positioning of pixels, preferably utilizing the voxel meshing method.

In the preferred embodiment of the invention, global porosity analysis or local porosity analysis is performed based on the CT scanning analysis results to determine porosities with different regional densities. In a preferred configuration, during scanning, global analysis can be performed by dividing into cubes of 1000 cubic millimeters, as well as conducting global porosity analysis in cubes of 100 cubic millimeters. The partition parameters can be customized according to the part geometry. The mentioned segmentation defines the unit volume, enabling the determination of porosity through correlation. Subsequently, based on the determined regional ratio, the tessellation algorithm operates, dividing the geometry/network into ‘n’ regions, and forming a substructure from these ‘n’ regions.

The results metrics of computed tomography produce measurements outputs which include porosity percentages and defects in the part. The positions corresponding to these defects and porosities, as well as volume and area outputs, are obtained. An example tomography output is provided in Table 1.

TABLE 1

| Defect | Radius | Diameter | Center | Center | Center | Volume |
|---|---|---|---|---|---|---|
| (Probability) | (mm) | (mm) | (x) | (y) | (z) | (mm\hat{ }3) |
| 4.16 | 1.29 | 2.57 | −23.59 | −1.44 | −21.28 | 0.51 |
| 3.16 | 0.84 | 1.67 | −23.16 | −2.23 | 0.30 | 0.25 |
| 1.46 | 0.96 | 1.93 | −24.95 | −2.10 | 1.04 | 0.23 |
| 1.37 | 0.85 | 1.71 | −24.14 | −2.21 | 2.90 | 0.17 |
| 1.01 | 0.69 | −1.37 | −24.22 | −0.86 | −2.20 | 0.22 |
| 1.00 | 1.05 | 2.10 | −24.57 | −2.73 | −4.85 | 0.33 |

In another preferred embodiment of the invention, the scanning of the alloy/part can be achieved using the x-ray method.

In another preferred embodiment of the invention, the scanning volume can vary depending on the equipment used. For example, scanning with a volume of one cubic meter can be performed. The objective of the scan is, by segmenting the geometry, to analyze how sphericity and compactness evolve at different sections of the material.

As provided in Table 1, information specifically related to defects/voids (probability) obtained from computed tomography (CT scans) is used to reveal undesired defects or porosity structure within the alloy—part and is used for analysis to provide improvement that is needed to eliminates the defects of the said alloy by the methodology of the invention

In another preferred embodiment of the invention, the geometry with pre-tessellated “n” regions can undergo a re-tessellation algorithm.

The material is segmented based on positions by percentage of the defects being detected in CT scan results. This segmentation can be adjusted according to the level of defects in the material. The said segmentation enables a more thorough analysis and enhance the development of the material. Upon examining each before-mentioned segmented region, it is observed that the defect percentage in each said region varies (compared to the analysis done as a single piece), therefore leading to increased resolution in the analysis step.

For example, when evaluating the CT scanning results of two pieces, the total computed defect density in both pieces may be the same. However, using the before-mentioned method, it is possible to identify defects concentrated in a specific region. Compared to a method where the defects are assumed to be homogeneously distributed on single piece versus another scenario where defects are concentrated in a specific area on the other piece.

FIG. 4 provides an image illustrating CT scanning results. For instance, in cases where generation of sub-structure and segmentation is not performed based on defects distribution, the total defect density of the leftmost piece and the adjacent piece in the image could be the same. However, as the distribution of defects are not homogeneous over the piece but rather concentrated in a specific region, it is not possible to detect critical defects within the second piece from the left. When segmented based on defect density, the highest density defects are taken into account as a separate segment (or region), allowing for a more thorough analysis of the alloy which enhances the precision of the analysis.

The porosities in the substructure consisting of “n” regions are cross-checked with heat treatment results and local porosity level and along with correlation data obtained from tensile tests to generate a database matrix based on which, “n” different material parameters are defined for the geometry, and thus the analysis is completed.

Within the scope of the invention, the analysis is conducted using the porous metal plasticity method. In this said method, analysis can be performed using Gurson or Rousselier methods based on the suitability condition of the said analysis.

Porous metal plasticity, which is a continuum mechanics analysis type, involves the stress tensor that written in the following form by which deviatoric and volumetric partitions can be obtained:

$$[ {σ}_{11} {σ}_{12} {σ}_{13} {σ}_{21} {σ}_{22} {σ}_{23} {σ}_{31} {σ}_{32} {σ}_{33} ]$$

Within the scope of the invention, J2-type plasticity utilizes the deviatoric part. In porous metal plasticity, changes occurring in the volumetric part σ₁₁, σ₂₂, σ₃₃, are translated to deformation behavior through porosity and other coefficients. Thus, stress distribution in relation with porosity is simulated.

Porous metal plasticity conducts analysis using local or global porosity percentage. The analysis is calculated using direct or explicit/implicit methods (similar to Newton-Raphson model). Starting from the initial structure with “p” state at time “t” (p=0, t=0), towards the (p+1) (t+1) states are calculated iteratively. In this iterative method, the continuous progression of (p+1) (t+1) is monitored to reach the values in the material's strength test. In the final stage, the analysis is conducted explicitly/implicitly, by ensuring the correlation.

In the preferred embodiment of the invention, parameters are assigned for “n” regions based on the analysis results. This enables the improvement of porosity distribution.

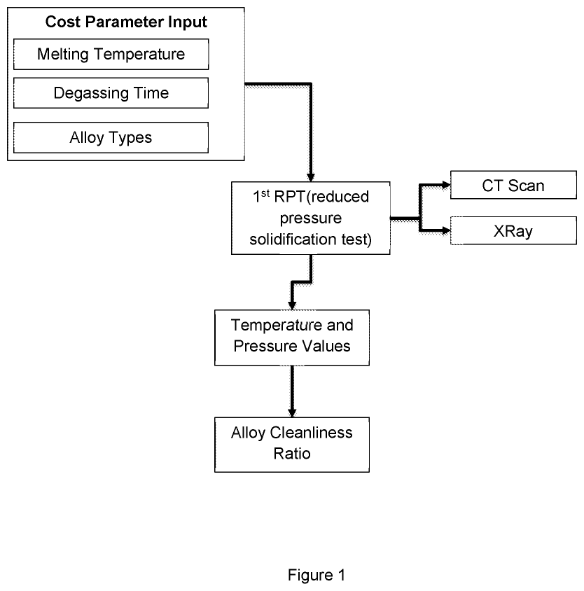

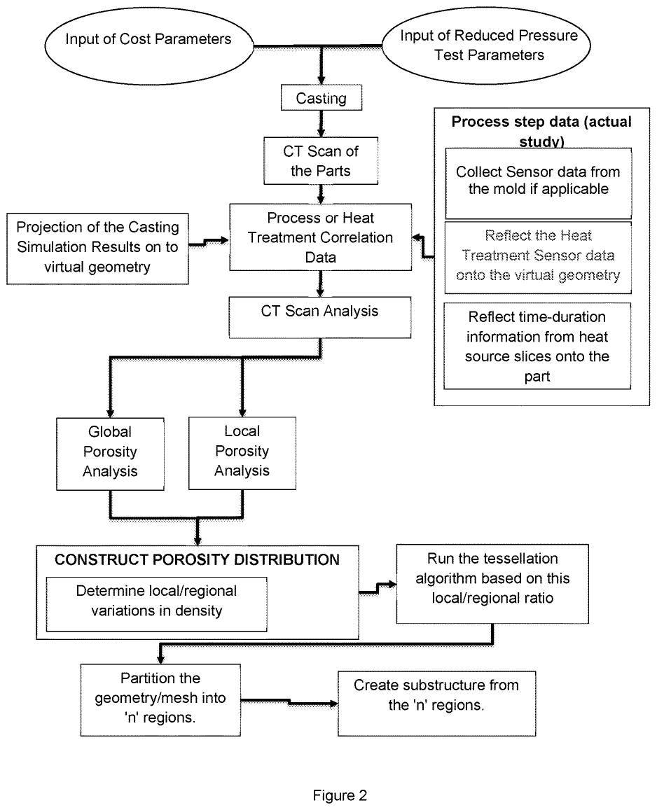

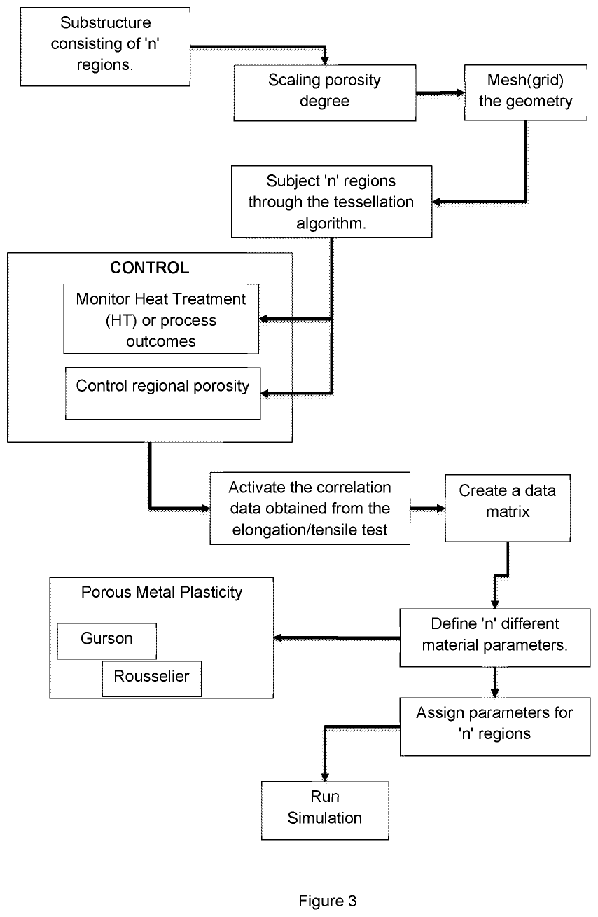

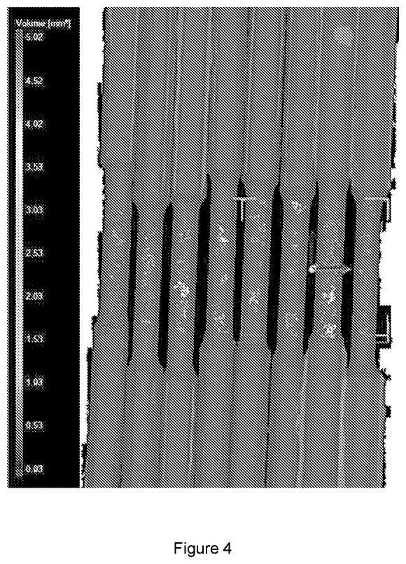

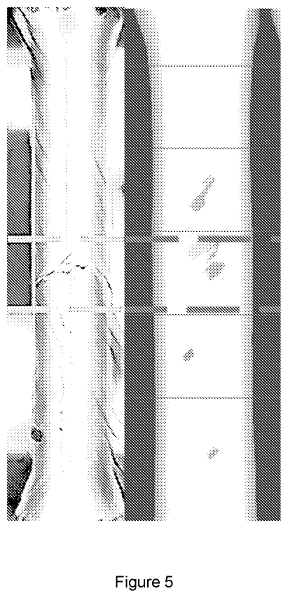

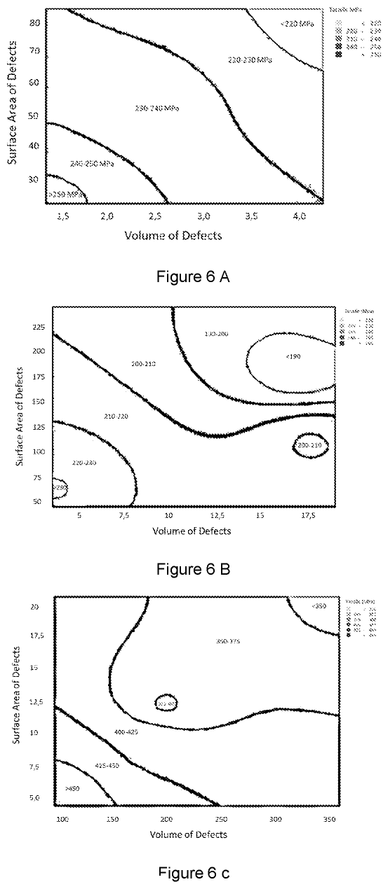

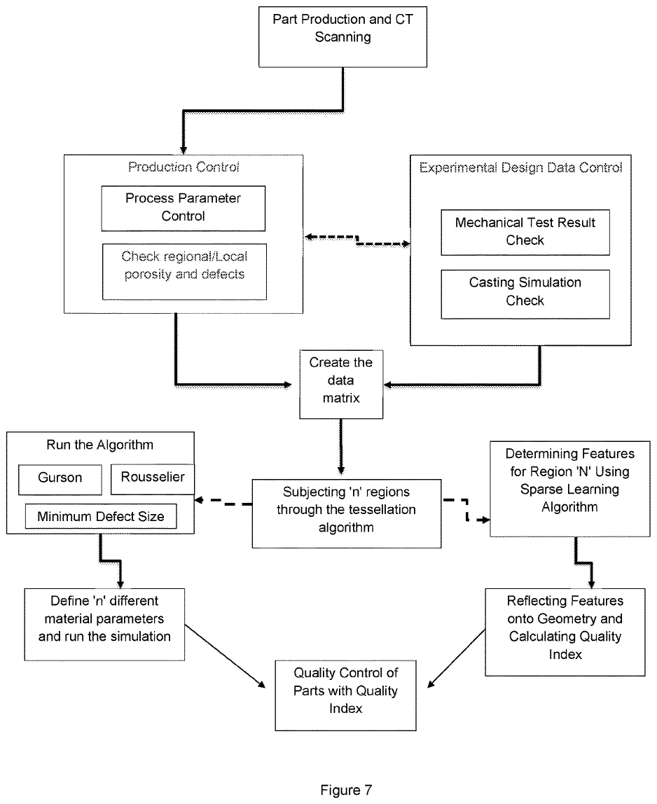

FIG. 5 provides an example image of “n” regions (chosen as 5). The before-mentioned segmentation allows to determine defect location in correlation with the defect percentage.

In another preferred embodiment of the invention, after the creation of the substructure from “n” regions, the stress concentration factor is assigned by defining the interface element to the determined porous regions. The said stress concentration factor is the ratio of the highest stress to nominal stress, causing irregularities that lead to noncontinuity within the material or geometry. This stress concentration factor is separately defined for each created region, enabling localized analyses.

In another preferred embodiment of the invention, the stress concentration factor can be calculated by correlating sphericity/compactness values for the said factor.

In another preferred embodiment of the invention, after the creation of the substructure of “n” regions, stress concentration is calculated using J2 plasticity. Then, J2 plasticity and stress concentration values are transferred as coefficients of local stress concentrations.

The Alloy Quality Index (AQI) is determined using a data map that includes heat treatment, tensile strength, and elongation data obtained from experimental results. A correlation map (tensile-volume and surface area ratio of CT) is constructed with the mechanical properties and the tomography results on the sample. Tomography data of the part is divided into random sections/regions, and AQI calculation is performed. The calculated said AQI data is reflected onto the part design data/scan data, thus allowing the observation of porosity/metal oxide density.

TABLE 2

| | fv- Porosity | | | |
|---|---|---|---|---|
| | level | | | |
| | coefficient | Tested | Calculated | |
| Alloy | at initial | Tensile | Tensile | % |
| Specimen | condition | (MPa) | (MPa) | Error |
| A3.1 | 0.0165 | 285 | 288 | 1.05 |
| A3.1 | 0.0193 | 281 | 284 | 1.06 |
| A3.2 | 0.002 | 306 | 306 | 0.0 |
| A3.2 | 0.004 | 295 | 298 | 1.02 |
| A3.3 | 0.018 | 292 | 286 | 2.1 |
| A3.3 | 0.0366 | 260 | 261 | 0.3 |

The Alloy Quality Index (AQI) is obtained from tomography data by assigning the volume and surface values of the defects to each unit volume into the following equation:

$$( YieldStrength + TensileStrength + Elongation ) - A ⋆ ( Volume of Defects ( DVol ) \cdot Surface of Defects ( Dsurf ) ) \hat{} b$$

In the said equation A and b are the alloy material coefficients. The Alloy Quality Index is calculated for each said divided volume. Thus, the alloy quality index is calculated for the smallest point of the structure.

In another preferred embodiment of the invention, damage evolution plasticity model, lifetime calculation, and strength calculation are conducted using the AI sparse learning algorithm.

In another preferred embodiment of the invention, various algorithms such as: Gurson-type damage evolution plasticity in continuum mechanics where specification of localization is incorporated into mathematical equations of the model or/and experimental Coffin-Manson, Paris-Erdogan and/or energy method which is based on the definition of minimum defect size as the initial damage condition are employed.

In the preferred embodiment of the invention, experimental design data control is ensured. In this context, mechanical test results and casting simulation results are examined. The obtained results allow the creation of a database matrix.

In another preferred embodiment of the invention, the before-mentioned “n” regions are meshed by tessellation algorithm and then a sparse learning algorithm is used to determine properties of “n” regions. Subsequently, the determined/calculated properties are projected onto the geometry of the part, and the quality index is calculated over the said geometry. This provides quality control of the part using the quality index.

Table 3, results of two specimens are given.

TABLE 3

| | Tensile | | Compactness | | Projected | Projected | Projected |
|---|---|---|---|---|---|---|---|
| | Strength | | Opening | | size on X | size on Y | size on Z |
| | MPa | Volume | Ratio | Sphericity | axis (mm) | axis (mm) | axis (mm) |
| Specimen 5 | 203 | 1.66 | 0.22 | 0.49 | 1.52 | 1.8 | 2.22 |
| Specimen 6 | 300 | 0.77 | 0.14 | 0.47 | 1.66 | 1.66 | 1.94 |

In the example given in Table 3, Sample 5 has a higher volumetric defect with high relative compactness which results in higher opening of the defect. Thus, the projected length size of the defects along the y-z axes are higher. The said algorithms of the invention can represent the defects by incorporating these singular values into the models according to their severity.

1. A method in order to increase the strength and facilitate the improvement of alloys which involves scanning and modeling the alloy with at least one computed tomography scanning method which allows the analysis of the inherent porosities and in particular, the metal oxide percentage in deformed regions is provided characterized in that; obtaining a sample with at least one casting process, conducting computed scanning to determine the location and density of the porosity regions of the material based on the scanning results, dividing the porous part into ‘n’ different virtual regions to establish a substructure, processing the identified porosities using a meshing method after tessellation and later analyze the determined porosity of the metal using the plasticity method.

2. To enhance the strength of alloys and to promote development of alloys, the method allows the analysis of porosities, metal oxide percentage, and the porosity specifically on the elongation/deformation regions according to claim 1, characterized by following steps:
a) Pre-production of the said alloy and conducting mechanical tests,
i) Determination of effective global/local representative volume dimensions through computed tomography of the said alloy
ii) Save the data of surface areas and volumes of defects detected in computed tomography scans of said alloy.
iii) Construction of a Test-Tomography correlation matrix/card.
b) Input of the parameters specific to alloy and part
c) Scanning the part by CT:
i) Determination of effective global/local representative volume through computed tomography (CT)
ii) Save the data of surface areas and volumes of the defects detected in CT scans of said alloy.
iii) Conducting CT analysis to determine porosity and metal oxide percentage by using the correlation data which includes heat treatment and cooling rate data.
d) Determination of local density differences of virtual regions and dividing the alloy's/part's virtual data into mesh grids
e) Division of the geometry data and/or mesh grids into “n” different specific regions based on the said determined regions having variable densities.
f) Construction of the substructure from before-mentioned “n” virtual regions.
g) Segmentation of regions into meshed structures using the Tessellation algorithm by determining the degree of porosity/metal oxide percentage of each region.
h) Correlate the data obtained from the test step with the data obtained from casting and CT scans.
i) Recall required data from the built-in data matrix from test and CT scan stage.
j) Determination of the alloy quality index and display on the geometry by projection.
k) Display of locations of Alloy Quality Index values for each subregion and identification of weak points in casting accordingly.
l) Creation of the porous metal plasticity model, defining “n” different materials for “n” different regions, recalling parameters from the data matrix, and running the simulation.
m) Projection of the obtained results onto the part and identify of weak points of the said part.

3. The method according to claim 2; characterized by, calculation the Alloy Quality Index as defined in process step j, using the following formula: Alloy Quality Index=(Yield Strength+Tensile Strength+Elongation)−A*(Volume of Defects*Surface of Defects)\hat{ }b, where the volume and surface of the defects are assigned for each unit volume obtained from tomography scan.

4. A method for analyzing alloys according to claim 3; characterized by, wherein the calculation is performed in each volume determined by division.

5. The method according to claim 2; characterized by, including the segmentation process into mesh grid using the tessellation algorithm, as mentioned in process step “d”.

6. The method according to claim 2; characterized by building a data matrix with heat treatment results and regional porosity values that also includes tensile test results that prior to processing step “i”.

7. The method according to claim 1; characterized by, retrieving strength results through correlation of test data by volume of defect, surface of defect, and fv (initial porosity ratio coefficient).

8. The method according to claim 7; characterized by, utilizing AI sparse learning algorithms to perform damage initiation plasticity modeling for lifetime calculation and strength analysis.

9. The method according to claim 7; characterized by, determining the alloy quality index as AQI=(Yield Strength+Tensile Strength+Elongation)−A*(Volume of Defect)\hat{ }b−A*(Volume of Defect*Surface of Defect)\hat{ }b.

10. The method according to claim 1; where the Gurson algorithm is used for the porous metal plasticity model.

11. The method according to claim 1; where the Rousselier algorithm is used for the porous metal plasticity model.

12. The method according to claim 1; where the Gurson-Tvergaard-Needleman algorithm is used for the porous metal plasticity model.

13. The method according to claim 1; where the Gologanu algorithm is used for the porous metal plasticity model.

14. The method according to claim 1; characterized by dividing the part or parts data into sections and builds grid/mesh based on their porosity density which is obtained by tomography scan.

15. The method according to claim 14; characterized by, creating tessellated substructures of the part based on the porosity locations and density that is obtained in tomography scan, dividing said part into sections, meshing it with voxel meshing method, and analyzing it using porous metal plasticity methods.

16. The method according to claim 1; characterized by, determining damage sensitivity by specifying crack size which considers projections of local or global dimensions of the defects along x, y, z axes or along xy, xz, yz planes, which assumes random orientation of the said defects to pinpoint crack initiation points.

17. The method according to claim 1; characterized by, creating a data matrix that contains heat treatment results and regional/local porosity metrics to implement into the porous metal plasticity algorithm.

18. The method according to claim 1; characterized by, defining “n” different material parameters for a substructure with “n” different regions wherein parameter allocation is performed after the porous metal plasticity analysis with a substructure of “n” different materials.

19. The method according to claim 1; characterized by performing global and local porosity analysis to determine different porosity densities among different regions of the part.

20. The method according to claim 2, characterized by; performing stress intensity factor assignment by defining interface/boundary elements for the regions where porosity is determined, after the substructure is constructed from “n” virtual regions.

21. The method according to claim 10; characterized by, calculation of the stress intensity factor is performed by correlating with sphericity/compactness values.

22. The method according to claim 2; characterized by, calculation of stress intensity factors by J2 plasticity following step f.

23. The method according to claim 1 or claim 19; characterized by, calculating and transferring local/regional stress intensity coefficients by J2 plasticity and by evolved stress concentration.

24. The method according to claim 1; characterized by, utilization of voxel meshing methodology.
